(19) United States
(12) Patent Application Publication
(10) Pub. No.: US 2004/0197750 A1
(43) Pub. Date: Oct. 7, 2004

(54) Methods for computer-assisted role-playing of life skills simulations

(76) Inventors: Joseph G. Donaher, Drexel Hill, PA (US); Kevin H. Franck, Bala Cynwyd, PA (US)

Correspondence Address: CAESAR, RIVISE, BERNSTEIN,, COHEN & POKOTILOW, LTD., 11TH FLOOR, SEVEN PENN CENTER, PHILADELPHIA, PA, 19103-2212, US

(21) Appl. No.: 10/403,038

(22) Filed: Apr. 1, 2003

(51) Int. Cl. G09B 19/00

(52) U.S. Cl. 434/236

(57) ABSTRACT

The inventive subject matter relates to methods for computer-assisted role-playing of a life skill simulation by one or more living subject(s). The inventive subject matter further relates to methods for operating a computer system to simulate a life skill environment.

### BACKGROUND OF THE INVENTION

1. Field of Invention

The inventive subject matter relates to methods for computer-assisted role-playing of a life skill simulation by one or more living subject(s). The inventive subject matter further relates to methods for operating a computer system to simulate a life skill environment.

2. Background

It is estimated that communication disorders, including but not limited to speech, language, and hearing disorders, affect one of every 10 people in the United States. A continuous burden to the progress of therapy for disabled or impaired persons is the incongruence between performance in the therapy room and functioning in everyday situations. Persons with a disability, especially children with developmental disabilities, routinely demonstrate targeted skills in isolated activities prior to performing the same task in functional, real-life situations. Unfortunately, such individuals and their families frequently become frustrated when they see the person with a disability performing at a certain level with the therapist, but not being able to duplicate that level at home, in school, or otherwise as a member of mainstream society. This can lead to feelings of frustration, guilt, and shame, especially in the case in which parents blame themselves for their child's difficulty. Children especially grow frustrated when they fail to maintain their skills in all settings.

In an attempt to increase the transitioning of skills into real life situations, therapists employ a battery of techniques. For example, live, one-on-one role-playing activities are often used to practice newly acquired skills in a variety of settings. The person with a disability may be asked to work with a therapist to perform tasks along a hierarchy starting with the easiest environments and systematically leading to more complex situations, or to use visualization techniques to place them in more challenging conditions. Therapists also frequently provide training and education to individuals who interact with a person with a disability in an effort to provide a continuum of care and support. Parents are routinely asked to complete assignments at home and teachers are asked to implement specific strategies in the classroom in an effort to generalize skills into more realistic settings.

The inventive subject matter approximates such live, naturalistic settings, promoting functional and realistic therapy practices. The person with a disability is transported into real-life situations which may include obstacles not experienced in the past, or not successfully dealt with in the past. In a safe and non-threatening way, the disabled student is encouraged to navigate through these barriers using problem solving skills. The person with a disability is able to practice scripts and explore a variety of ways to tackle life-skills challenges. This promotes increased learning, self-confidence, and comfort in dealing with challenges that disabled individuals face in everyday living.

More particularly, the inventive subject matter allows students to enter a school-based setting and maneuver through activities in a safe and non-threatening way. The person with a disability is encouraged to navigate through everyday routines which may prove problematic in light of their challenges. Students are asked to act out a variety of options to see what works best for them in a specific situation. These may include giving an oral presentation in class, answering questions posed by the teacher, interacting on an interpersonal level with other students, or operating within the environmental constraints of an average classroom. By role-playing through these common situations, the person with a disability will gain a heightened sense of confidence in their abilities, which may translate into higher level functioning and increased transitioning of targeted skills. In order to create the tools necessary to fulfill these objectives, the inventive subject matter provides realistic looking images that will truly challenge persons with a disability and allow them to feel transported into a new setting. In addition, the inventive subject matter provides flexibility to adapt the program to a variety of clinical needs, and encouragement for the person with a disability, their family, and the clinician. This will encourage active participation and entry into the virtual world provided by the inventive subject matter, and development of exciting and creative programs which entice the person with a disability to participate.

### SUMMARY OF THE INVENTION

The inventive subject matter relates to a method for computer-assisted role-playing of a life skill simulation by one or more living subject(s), comprising the steps of:

A) utilizing an input device of a computer system, selecting a life skill simulation available through said computer system;

B) utilizing an input device of said computer system, selecting at least two characters, comprising:

(i) a first character in said simulation which is an active character played by a living subject,

(ii) a second character in said simulation which is either an active character played by an additional living subject or a simulated character generated by said computer system, and

(iii) additional optional character(s), each of which is either an active character played by an additional living subject or a simulated character generated by said computer system;

C) utilizing an input device of said computer system, selecting for each said character a disability mode for each of one or more selected disabilities,

wherein each said disability mode is selected from the group consisting of the presence of one or more symptoms of a selected disability and the absence of symptoms of the selected disability;

D) utilizing an output device of said computer system, presenting each subject with a visual stimulus and/or an aural stimulus permitting a response from said subject;

E) monitoring a response, or lack thereof, for effectiveness of each subject in achieving a pre-determined goal of said life skill simulation;

F) assessing the effectiveness of each said response, or lack thereof, in achieving said pre-determined goal; and

G) providing feedback to a subject regarding the effectiveness of the subject's response in achieving said pre-determined goal.

In another aspect, the inventive subject matter relates to a method for operating a computer system to simulate a life skill environment, comprising the steps of:

A) storing a life skill simulation having a pre-determined goal on an information storage and retrieval device of a computer system;

B) utilizing an input device of said computer system, selecting a life skill simulation and a pre-determined goal for said life skill simulation;

C) utilizing an input device of said computer system, selecting at least two characters comprising:

(i) a first character in said simulation which is an active character played by a living subject,

(ii) a second character in said simulation which is either an active character played by an additional living subject or a simulated character generated by said computer system, and

(iii) additional optional character(s), each of which is either an active character played by an additional living subject or a simulated character generated by said computer system;

D) utilizing an input device of said computer system, selecting for each said character a disability mode for each of one or more selected disabilities,

wherein each said disability mode is selected from the group consisting of the presence of one or more symptoms of a selected disability and the absence of symptoms of the selected disability;

E) utilizing an output device of said computer system, presenting each subject with a visual stimulus and/or an aural stimulus permitting a response from said subject; and

F) monitoring a response, or lack thereof, by said subject for effectiveness of said response in achieving said goal.

### BRIEF DESCRIPTION OF THE DRAWINGS

FIG. 1 is a flowchart depicting the steps traversed in a method for computer-assisted role-playing of a life skill simulation by one or more living subject(s), according to one embodiment of the inventive subject matter.

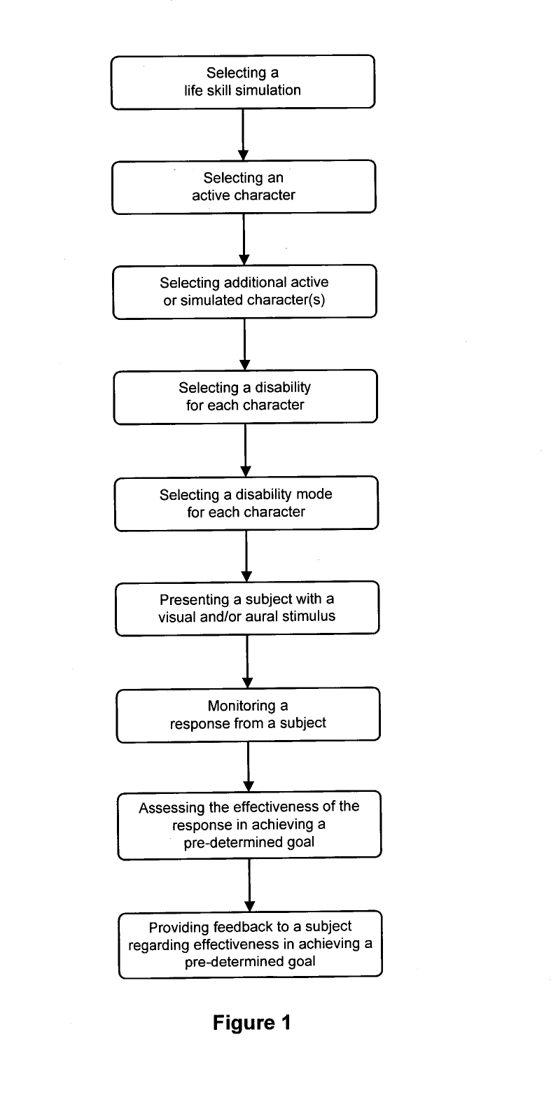

FIG. 2 is a flowchart depicting the steps traversed to operate a computer system to simulate a life skill environment according to one embodiment of the inventive subject matter.

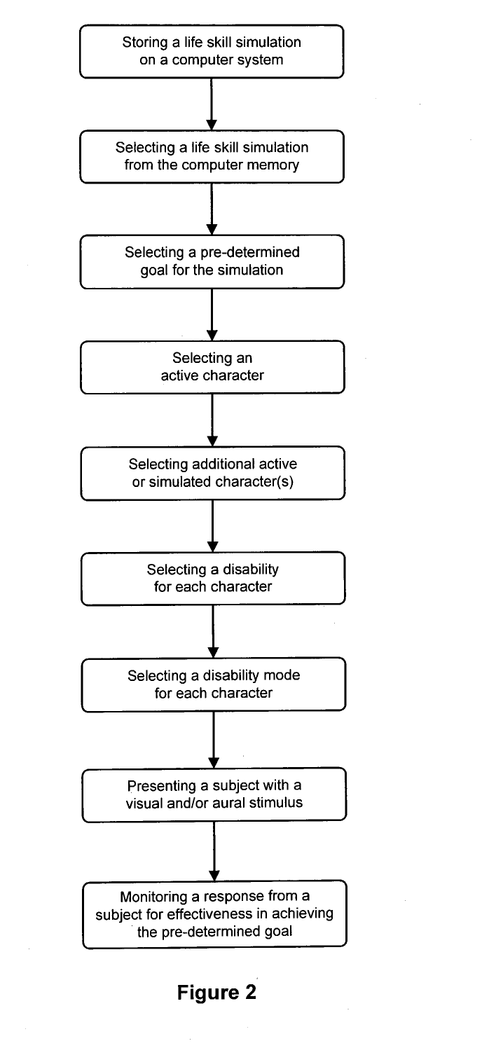

### DETAILED DESCRIPTION OF THE INVENTION

Definitions

“Autism” refers to a developmental disability significantly affecting verbal and non-verbal communication and social interaction, generally evident before age three.

“Deafness” refers to a hearing impairment which is so severe that an individual is impaired in processing linguistic information through hearing, with or without amplification.

“Deaf-Blindness” refers to simultaneous hearing and visual impairments, the combination of which causes such severe communication and other developmental and educational problems that an individual cannot be accommodated in special education programs solely for deafness or blindness.

“Hearing Impairment” refers to diminution in the sense of hearing, whether permanent or fluctuating, but which is not included under the definition of “deafness” above.

“Mental Retardation” refers to significantly subaverage general intellectual functioning existing concurrently with deficits in adaptive behavior and generally manifested during the developmental period.

“Multiple Disabilities” refers to simultaneous impairments, other than deaf-blindness, such as mental retardation/blindness, mental retardation/ orthopedic impairment, etc., the combination of which causes such severe problems that an individual cannot be accommodated in a program designed solely for one of the impairments.

“Neurological impairment” refers to a diminution or other abnormality in the functioning of the nervous system, and includes such exemplary, non-limiting disorders as muscular dystrophy, multiple sclerosis, spina bifida, Parkinson's disease, SDAT (Alzheimer's disease), amyotrophic lateral sclerosis, spinal cord injury, and peripheral neuropathy. Other exemplary neurological disorders include, but are not limited to, trigeminal neuralgia, glossopharyngeal neuralgia, Bell's Palsy, myasthenia gravis, progressive muscular atrophy, progressive bulbar inherited muscular atrophy, herniated, ruptured or prolapsed invertebrate disk syndromes, cervical spondylosis, plexus disorders, thoracic outlet destruction syndromes, and Guillain-Barre syndrome.

“Orthopedic Impairment” refers to a severe orthopedic impairment, and includes, for example, impairments caused by a congenital anomaly, for example clubfoot, absence of some member, etc.; impairments caused by disease, for example poliomyelitis, bone tuberculosis, etc.; and impairments from other causes, for example cerebral palsy, amputations, and fractures or burns which cause contractures.

“Other Health Impairment” refers to having limited strength, vitality, or alertness due to chronic or acute health problems such as a heart condition, tuberculosis, rheumatic fever, nephritis, asthma, sickle cell anemia, hemophilia, epilepsy, lead poisoning, leukemia, or diabetes.

“Emotional Disturbance” refers to a condition exhibiting one or more of the following characteristics over a long period of time and to a marked degree: (A) an inability to learn which cannot be explained by intellectual, sensory, or health factors; (B) an inability to build or maintain satisfactory interpersonal relationships with peers and teachers; (C) inappropriate types of behavior or feelings under normal circumstances; (D) a general pervasive mood of unhappiness or depression; or (E) a tendency to develop physical symptoms or fears associated with life skills problems.

“Communication” is the exchange of information, the sending and receiving of messages. It is a two-way interaction and requires participation of a sender and a receiver. A message is encoded, transmitted and decoded. Communication breakdowns can occur if either party has difficulty performing their role. If the sender does not speak clearly or intelligibly, his/her message may not be received. If the sender does not use language appropriately, in a meaningful way, the message may not be received. If the receiver has a hearing impairment, an oral/spoken message may not be received. If the receiver has difficulty understanding language, they may not be able to decode the message.

“Language” is a shared code or system that represents concepts and ideas through the use of arbitrary symbols. It is rule-governed and shared by a given community. Typically, we use oral and written language to communicate.

“Language disorder” refers to an impairment in the ability to understand and/or use words in context, both verbally and nonverbally. Some characteristics of language disorders include improper use of words and their meanings, inability to express ideas, inappropriate grammatical patterns, reduced vocabulary, and inability to follow directions.

“Speech” is a motor act. It is the production of sounds in meaningful combinations by the lips, tongue, teeth, palate, vocal cords, and lungs for communication.

“Speech disorder” refers to difficulties producing speech sounds or problems with voice quality, which may be characterized by an interruption in the flow or rhythm of speech. Speech disorders may be problems with the way sounds are formed, called articulation or phonological disorders, or they may be difficulties with the pitch, volume, or quality of the voice. People with voice disorders may have trouble with the way their voices sound.

“Speech-language impairment” refers to disorders of human communication, and related areas such as oral motor function. This includes, for example, disorders of speech, language and swallowing. Communication disorders can be congenital or acquired, and can affect individuals of any age. Such disorders range from simple sound substitutions to the inability to understand or use language or use the oral-motor mechanism for functional speech and feeding. Some causes of speech and language disorders include hearing loss, neurological disorders, brain injury, mental retardation, drug abuse, physical impairments such as cleft lip or palate, and vocal abuse or misuse. Exemplary communication disorders include stuttering, impaired articulation, cluttering, language impairment, and voice impairment.

“Stuttering” refers to a disorder of speech fluency that interrupts the forward flow of speech. All individuals are disfluent at times, but what differentiates the person who stutters from someone with normal speech disfluencies is the kind and amount of the disfluencies. Characteristics of stuttering include repetition of sounds, parts of words, whole words, and phrases; prolongation or stretching of sounds or syllables; tense pauses, hesitations, and/or no sound between words; and speech that occurs in spurts.

“Cluttering” refers to a fluency disorder characterized by a rapid and/or irregular speaking rate, excessive disfluencies, and often other symptoms such as language or phonological errors and attention deficits. Cluttering involves excessive breaks in the normal flow of speech -that seem to result from disorganized speech planning, talking too fast or in spurts, or simply being unsure of what one wants to say.

“Articulation” is the production of speech sounds. “Articulation disorder” refers to a disorder in which a person is hard to understand because they say sounds incorrectly. They might substitute one sound for another, distort the sound, or omit it entirely.

“Phonology” is the science of speech sounds and sound patterns. “Phonological disorder” refers to the failure to use conventional rules about how sounds can be made or combined.

“Aphasia” refers to a language impairment caused by damage to the areas of the brain responsible for language function. Damage to the brain can be caused by stroke, tumor or head injury. Different aspects of language can be affected to varying degrees depending on the location and severity of the damage.

“Verbal Apraxia”, or apraxia of speech, refers to a motor disorder in which volitional or voluntary movement is impaired without muscle weakness, producing an impairment in the sequencing of speech sounds. Apraxic speakers grope for the correct word; they may make several attempts at a word before they get it right. The errors heard in apraxic speech are unpredictable. “Acquired apraxia” refers to apraxia that results from an incident causing brain damage, such as stroke, head injury, brain tumors, toxins, or infections; acquired apraxia can be linked to specific lesion sites. It can so severe that the individual is unable to initiate speech or so mild that an individual only has occasional difficulties in conversation pronouncing multi-syllabic words. “Developmental apraxia” refers to a disorder that is present from birth. There are generally no specific lesion sites in the brain in cases of developmental apraxia.

“Dysarthria” refers to a speech disorder that results in a weakness or incoordination of the speech muscles, affecting both children and adults. Speech is slow, weak, imprecise, or uncoordinated. In both adults and children, dysarthria can result from head injury. “Childhood dysarthria” can be congenital or acquired. It is often a symptom of a disease, such as cerebral palsy, Duchenne muscular dystrophy, myotonic dystrophy, Bell's palsy, or the like. In adults, dysarthria is can be caused by stroke; degenerative disease such as Parkinson's, Huntington's, amyotrophic lateral sclerosis, multiple sclerosis, or myasthenia gravis; infections such as meningitis; brain tumors; and exposure to toxins resulting from drug or alcohol abuse, lead poisoning, carbon monoxide, etc.

“Traumatic Brain Injury” refers to an injury to the brain caused by an external physical force, brain injuries that are congenital or degenerative, or brain injuries induced by birth trauma resulting in total or partial functional disability or psychosocial maladjustment, or both.

“Visual Impairment” refers to an impairment to vision which, even with correction, results in loss of vision, including both individuals with partial sight and those with blindness.

“Low vision” refers to a severe visual impairment, not necessarily limited to distance vision. Low vision applies to all individuals with sight who are unable to read the newspaper at a normal viewing distance, even with the aid of eyeglasses or contact lenses. They use a combination of vision and other senses to learn, although they may require adaptations in lighting or the size of print, and, sometimes, braille.

“Legally blind” indicates that, even with optimal correction, a person has less than 20/200 vision in the better eye or a very limited field of vision, i.e. 20 degrees at its widest point.

“Life skill” or “living skill” refers to a social-emotional skill or attribute important for the success of an individual in society. A “life skill simulation” refers to simulated environment which includes, but is not limited to, environments such as at school, either inside or outside a school classroom, at work, at home, and in public places. Non-limiting examples of the types of living skills which may contribute to success in these environments include, but are not limited to, thinking and reasoning skills, personal qualities, skills for managing resources, interpersonal skills, skills for managing information, and skills and knowledge related to systems. Particular examples further include empathy, assertiveness, impulse control, management of feelings, ability to relate to others, decision-making skills, self-understanding, connection to community, spirit of inquiry, and acceptance of responsibility. One or a combination comprising more than one of the these skills may be practiced in a particular life skill simulation.

“Active character” refers to a human participant in the methods of the invention, as distinguished from a computer-generated character.

“Simulated character” refers to a computer-generated character in the methods of the invention, as distinguished from a human participant.

“Disability mode” refers to either (1) the presence and degree of each disability which is selectable for an active character or a simulated character in the methods of the invention, or (2) the absence of a disability.

“Virtual reality” refers to either (1) the experience of immersion in an artificial, three-dimensional simulation environment that is generated by a computer or other technology, or (2) the experience of applications that are not fully immersive, but which provide, for example, navigation through a three-dimensional environment, having pseudo look-around and walk-trough capabilities, on a graphics monitor.

“Virtual reality headset” refers to a device which covers the user's eyes and ears, and which incorporates at least a 2-dimensional image display system, and preferably a 3-dimensional image display system, along with at least a stereo sound system, and preferably a surround sound system. Additionally, a stereoscopic headset with tracking capability more actively places a human being within a simulated environment. Such technologies are commercially available, and their features and operation are known to artisans of ordinary skill in the art.

“Display” refers to a device for the electromechanical reproduction of visual images, comprising a display area and a image generator device for depicting images upon the display area. The term is used broadly herein, and refers, without limitation, to cathode ray tube devices, liquid crystal display devices, plasma display devices, projection devices, and the like, including without limitation virtual reality wrap-around display devices.

“Speaker” refers to a device for the electromechanical reproduction of sound. The term is used broadly herein, and refers, without limitation, to wired and wireless loudspeakers, headphones, earphones, earbuds, hearing aids, cochlear implants, and the like.

### Methods for Computer-Assisted Role-Playing of a Life Skill Simulation

The inventive subject matter uses virtual reality technology to approximate naturalistic settings, which promotes functional and realistic therapy practices. For example, in a safe and nonthreatening way, a disabled subject is transported into a life skill simulation of a real-life situation, and is encouraged to navigate through everyday routines which may prove problematic in light of the limitations or disabilities of the individual. The inventive subject matter also allows parents, caregivers, educators, and others to enter a life skill simulation setting and maneuver through activities with a simulated disability to gain a heightened sense of the obstacles faced daily by a person with a disability. Thus, the inventive subject matter relates to a method for computer-assisted role-playing of a life skill simulation by one or more living subject(s), comprising the steps of:

A) utilizing an input device of a computer system, selecting a life skill simulation available through said computer system;

B) utilizing an input device of said computer system, selecting at least two characters, comprising:

(i) a first character in said simulation which is an active character played by a living subject,

(ii) a second character in said simulation which is either an active character played by an additional living subject or a simulated character generated by said computer system, and

(iii) additional optional character(s), each of which is either an active character played by an additional living subject or a simulated character generated by said computer system;

C) utilizing an input device of said computer system, selecting for each said character a disability mode for each of one or more selected disabilities,

wherein each said disability mode is selected from the group consisting of the presence of one or more symptoms of a selected disability and the absence of symptoms of the selected disability;

D) utilizing an output device of said computer system, presenting each subject with a visual stimulus and/or an aural stimulus permitting a response from said subject;

E) monitoring a response, or lack thereof, for effectiveness of each subject in achieving a pre-determined goal of said life skill simulation;

F) assessing the effectiveness of each said response, or lack thereof, in achieving said pre-determined goal; and

G) providing feedback to a subject regarding the effectiveness of the subject's response in achieving said pre-determined goal.

It is expected that one of ordinary skill in the art will understand that a computer system refers generally to a device having at least an input device, a processor, a memory storage and retrieval device, and an output device. In the methods of the inventive subject matter, the computer system will receive input relating to said life skill simulation from said subject(s), will process said input, and will display output relating to said life skill simulation to said subject(s). It is also expected that one of ordinary skill in the art will understand that a computer system refers any one of many devices—for example personal desktop, notebook, and laptop computers; networked computers; mainframe computers; and the like—which have an input device, an output device, a processor, and a memory storage and retrieval device. Computer systems are commercially available and well known in the art.

The inventive subject matter will operate out of a computer and preferably include at least one virtual reality headset. More preferably two virtual reality headsets will be provided. Preferably, the computer will be a laptop to ease in transportation. The program will include, for example, a virtual classroom setting with realistic looking images drawn from actual classrooms. The visual set-up will include, among other scenes, a fully surrounded classroom atmosphere with options to simulate a variety of classroom configurations.

In the virtual classroom example, desks are provided and are filled with virtual students, who can be altered to display varying levels of attention and compliance. The physical characteristics of the room will include options on the seating arrangements, such as desk vs. chairs, classroom vs. lecture, and the location of the teacher in one end or in the middle of the classroom. The acoustic characteristics of the classroom will also be alterable for background noise and various levels of distortion.

In a preferred embodiment, said computer system comprises a virtual reality input device, a virtual reality output device, a computer processor, an information storage and retrieval device, and a set of computer-readable instructions for processing said input and generating said output.

Virtual Reality Technology. Virtual reality refers herein to applications that may be either fully immersive, or not fully immersive, consisting of at least (a) a display; (b) one or more speakers; and (c) an input device.

The unique characteristics of immersive virtual reality can be summarized as follows: head-referenced viewing provides a natural interface for the navigation in three-dimensional space and allows for look-around, walk-around, and fly-through capabilities in virtual environments; stereoscopic viewing enhances the perception of depth and the sense of space; the virtual world is presented in full scale and relates properly to the human size; realistic interactions with virtual objects via, for example, a data glove and similar devices allow for manipulation, operation, and control of objects in the virtual world; the convincing illusion of being fully immersed in an artificial world can be enhanced by auditory, haptic, and other non-visual technologies; networked applications allow for shared virtual environments.

The term virtual reality may also be used for applications that are not fully immersive. All variations of virtual reality are included within the scope of the present inventive subject matter. This includes, for example, mouse-controlled navigation through a three-dimensional environment on a graphics monitor, stereo viewing from the monitor via stereo glasses, stereo projection systems, and other arrangements which provide pseudo look-around and walk-trough capabilities on a graphics monitor.

Additionally, the ongoing development of Virtual Reality Modeling Language (“VRML”) provides three-dimensional worlds with integrated hyperlinks. VRML 2.0 is an international ISO/IEC standard. The viewing of VRML models via a VRML plug-in for Web browsers is usually done on a graphics monitor under mouse-control and, therefore, not fully immersive. However, the syntax and data structure of VRML provide an excellent tool for the modeling of three-dimensional worlds that are functional and interactive and that can, ultimately, be transferred into fully immersive viewing systems.

Further, other virtual reality technologies combine virtual and real environments. For example, motion trackers may be employed to monitor the movements of subjects for subsequent studies in immersive environments. The technologies of augmented reality allow for the viewing of real environments with superimposed virtual objects. Telepresence systems such as telemedicine and telerobotics immerse a viewer in a real world that is captured by video cameras at a distant location and allow for the remote manipulation of real objects via robot arms and manipulators.

In one embodiment of the inventive subject matter, a display is a typical head mounted device which may house two miniature display screens and an optical system that channels the images from the screens to the eyes, thereby presenting a stereo view of a virtual world. An optional motion tracker continuously measures the position and orientation of the user's head and allows the image generating computer to adjust the scene representation to the current view. As a result, the viewer can look around and walk through the surrounding virtual environment.

In an alternate embodiment of a display, screens and optical system are housed in a box that is attached to a multi-link arm. The user looks into the box through two holes, sees the virtual world, and can guide the box to any position within the operational volume of the device. Head tracking is accomplished via sensors in the links of the arm that holds the box.

In another alternate embodiment, the display may provide the illusion of immersion by projecting stereo images on the walls and floor of a room-sized cube. Persons wearing stereo glasses can enter and walk freely inside the cube. A head tracking system continuously adjusts the stereo projection to the current position of the viewer.

A variety of input devices, like data gloves, joysticks, and hand-held wands, allow the user to navigate through a virtual environment and to interact with virtual objects. Directional sound, tactile and force feedback devices, voice recognition, and other technologies are optionally employed to enrich the immersive experience and to create more tactile interfaces.

As the technologies of virtual reality evolve, it is expected that virtual reality will reshape the interface between people and technology by offering new ways for the communication of information, the visualization of processes, and the creative expression of ideas. A virtual environment can represent any three-dimensional world, either real or abstract. This includes, for example, real systems like buildings, landscapes, human anatomy, sculptures, classrooms, the home, and so on. As provided in the present inventive subject matter, a useful application of virtual reality provides applications to help persons with a disability, especially children, to practice and improve important functional skills.

The inventive subject matter uses virtual reality technology to approximate naturalistic settings, which promotes functional and realistic therapy practices in a safe and nonthreatening environment in which the subject is able to practice scripts and explore a variety of ways to tackle the disabily of a person with a disability. This will promote increased understanding, learning, self-confidence, and comfort in dealing with the challenges that disabled individuals face in everyday living. The life skill simulation settings and activities include the ability to experience a simulated disability, for example stuttering or a hearing loss. Exemplary classroom activities include giving an oral presentation to the class, answering questions posed by the teacher, interacting on an interpersonal level with other students, or operating within the environmental constraints of an average classroom. By role-playing common situations, the person with a disability will gain familiarity, comfort, and self-confidence in otherwise troubling situations. By role-playing common situations through the eyes of a person with a disability, family and professionals will gain a heightened sense of the obstacles faced daily by the person with a disability.

In another aspect of the invention, input is received from a subject through a device selected from the following exemplary group: a keyboard, a pointing device such as mouse or mousepad, a joystick device, a control button, a microphone, and combinations thereof. One of ordinary skill in the art will appreciate that any computer input device may be utilized in the methods of the invention, and that such devices are readily interchangeable within the scope of the invention.

Similarly, in another aspect of the invention, output is displayed to a subject through a device selected from the following exemplary group: a display, a speaker, and combinations thereof. As above, one of ordinary skill in the art will appreciate that any computer output device may be utilized in the methods of the invention, and that such devices are readily interchangeable within the scope of the invention.

As discussed above, in a more preferred embodiment, output is displayed to a subject through a display and one or more speaker(s) incorporated into a virtual reality headset.

Life Skills Simulations. In another aspect of the invention, a life skill simulation is selected from the group consisting of a school classroom simulation, a school recess simulation, a school library simulation, a school restroom simulation, a playtime simulation, a sports participation simulation, a locker room simulation, a social simulation, and a mealtime simulation. One or more life skill(s) may be practiced in a particular life skills simulation. One of ordinary skill in the art will appreciate that a life skills simulation may encompass virtually any aspect of life that it may be useful to simulate. Any environment which is simulated in the methods of the present invention, whether or not selected from the list of exemplary simulation environments above, is within the scope of the invention so long as practicing life skills in that simulated environment will reasonably contribute to improvement or success in a corresponding real life environment.

One aspect of the inventive subject matter is to create a rehabilitative tool for persons with disabilities. In an attempt to increase the likelihood of successfully transitioning skills learned during the rehabilitation process into real life situations, virtual reality technology is employed to approximate naturalistic settings, which promotes functional and realistic therapy practices.

Thus, in a particularly preferred embodiment, the life skill simulation is a classroom simulation. It is expected that a classroom simulation may include one or more teachers of various levels of teaching ability and knowledge of accommodations required for disabled or impaired persons, as well as numerous students of various demeanors, ranging from friendly and helpful to confrontational and malicious. The classroom was chosen as an exemplary environment because it is frequently a difficult environment for children with disabilities. For example, a child is transported into a typical classroom, which may include either physical obstacles, psychological obstacles, or both, which were not experienced in the past or were optimally dealt with in the past. In a safe and non-threatening way, the individual is encouraged to navigate through these obstacles using problem solving skills. The individual can then practice scripts and explore a variety of ways to tackle these challenges. This will promote increased learning, self-confidence, and comfort level, which is expected to translate into higher level functioning and increased transitioning of targeted skills.

In another aspect of the invention, other characters present in the simulation are selected from the following exemplary group: one or more disabled or impaired person(s), one or more teacher(s), one or more counselor(s), one or more physician(s), one or more peer(s) of a disabled or impaired person, one or more neutral observer(s), and one or more other person(s) appropriate to the particular life skill simulation. In the exemplary classroom embodiment, the invention provides manipulation of at least three roles: a person with a disability, a classroom teacher, and a student in the classroom. Individuals are able to enter the classroom and assume any of these roles simply by selecting from the program options.

The user will make preliminary choices regarding the teacher. For instance, a regular mode allows an individual to speak/interact independently in this role. One option includes, for example, having an automated lesson plan where a simulated teacher lectures on a variety of topics with varying cognitive levels. Another option is for the simulated teacher to ask questions on a variety of topics, allowing students to practice answering questions in the classroom. Another option is for someone to play the role of another individual in the classroom. This allows a clinician and a subject to role-play through interpersonal and/or social interactions. Such interactions may include, for example, working through issues of teasing and other social, pragmatic situations.

One of ordinary skill in the art will recognize from the description of the inventive subject matter herein that an active participant in the simulation may take any role, and that the number and complexity of characters is only limited by the limits of the particular computer equipment utilized to run the simulation. Thus, the number and type of characters in the simulation is virtually unlimited, given sufficient computer resources. It is intended that the inventive subject matter encompass any number of characters of any complexity.

In a more preferred embodiment, the simulation characters comprise one active character and one simulated character, one active character and a plurality of simulated characters, two active characters, or two active characters and at least one simulated character.

Simulated Disabilities. Another aspect of the inventive subject matter is to advance parent, caregiver, and professional training and understanding of persons with disabilities. By allowing others to maneuver through activities while experiencing one or more disabilities, the program offers a realistic glimpse into the everyday obstacles experienced by persons with disabilities. A feature of the inventive subject matter is the option for any participant to assume any role, with any disability or lack thereof, in order to educate and desensitize the participant to the experiences of a person having the characteristics and limitations assigned to the character in the simulation.

While playing a person with a disability, the user has the disability simulated electronically. For example, the user decides whether to use a regular mode, which allows the user to speak, hear, and otherwise interact in typical fashion, or whether to use a disability mode, which allows the user to simulate one or more disabilities. For example, the user may choose to simulate a speech-language disorder such as stuttering by choosing an option which provides delayed auditory feedback akin to that found in stuttering, or to simulate a hearing loss by selecting from the following exemplary hearing loss options: unilateral loss, mild/moderate/severe hearing loss, hearing aid user, FM unit user, or cochlear implant recipient.

Thus, in another aspect of the invention, the disability attributed to a character is selected from the following exemplary group: hearing impairment, deafness, speech-language impairment, communication disorders, visual impairment, neurological impairment, mental retardation, emotional disturbance, acquired brain injury, cerebral palsy, attention deficit hyperactivity disorder, mobility impairment, orthopedic impairment, other health impairment, autism, and combinations thereof. As described herein, the inventive subject matter provides methods for the training and rehabilitation of individuals having such disabilities. One of ordinary skill in the art will recognize that the list of disabilities above is not exhaustive; the inventive subject matter is intended to encompass any disability for which a simulation can be devised.

In a more preferred embodiment, the disability to be attributed to a character is hearing impairment selected from the following exemplary group: minimal hearing loss, moderate hearing loss, severe hearing loss, unilateral hearing loss, total hearing loss, acclimation to hearing aid device(s), and acclimation to cochlear implant device(s). The inventive subject matter is not limited to this exemplary list of hearing impairment conditions, but is intended to encompass any hearing disability for which a simulation can be devised.

In another preferred embodiment, the disability to be attributed to a character is speech-language impairment selected from the following exemplary group: stuttering, cluttering, impaired articulation, aphasia, dysarthria, apraxia, language impairments, and voice impairments. The inventive subject matter is not limited to this exemplary list of speech-language impairment conditions, but is intended to encompass any speech-language disability for which a simulation can be devised.

In another aspect of the invention, the step of assessing the effectiveness of a response includes the step of assessing the subject's ability to manage and successfully perform tasks associated in the simulation with a life skill goal. Thus, a life skill goal will be associated with particular tasks, with some user responses contributing to success in achieving the goal and some responses contributing to failure. The computer system can be programmed to apply objective, pre-determined parameters to produce system output indicating success or failure to the user. Alternately, a clinician, therapist, or other operator can actively monitor a response from an active subject, subjectively assess its effectiveness in producing a desired goal, and manipulate system output to indicate success or failure to the user.

Exemplary Disabilities. The methods of the present invention are intended to apply, by way of example and not limitation, to individuals having, or experiencing in a simulation, any of the following types of disabilities: autism, deafness, deaf-blindness, hearing impairments including deafness, mental retardation, multiple disabilities, orthopedic impairments, other health impairments, serious emotional disturbance, specific learning disabilities, speech-language impairments, traumatic brain injury, visual impairments including blindness, and combinations thereof. These disabilities are known to artisans of ordinary skill in the art, for example, through the content and legislative history of the Individuals with Disabilities Education Act. It is to be understood that the inventive subject matter provides methods for the training and rehabilitation of all disabled and impaired individuals, as described for the following non-limiting, exemplary disabilities.

1. Hearing Disabilities. Hearing impairment is a limitation in the ability to hear sounds, whether permanent or fluctuating, which adversely affects educational and social success but which is not included under the definition of deafness. Deafness is a hearing impairment which is so severe that a individual is impaired in processing linguistic information through hearing, with or without amplification, which adversely affects educational and social success.

Historically, the education of deaf children has taken place in residential schools for the deaf. In these programs, deaf children attended classes by day and are supervised in living situations during after-school and weekend hours. The country's demographics with regard to deafness contributed to the development of strategically located state schools for the deaf in virtually every state. Broad expansion of state facilities was undertaken in the early 1970s as the children of the rubella epidemic of the late 1960s were identified and enrolled in school programs. Thus, state residential schools for the deaf were a center for education and socialization and a place where enculturation into the Deaf Community could take place.

The Education of All Handicapped Children Act identifies the right of all children with special needs to be educated in the least restrictive environment. This is interpreted by many as synonymous with mainstreaming, or the education of children with disabilities alongside their nondisabled peers in a mainstream school. Inclusive education also refers to inclusion in the mainstream classroom, but with significant special education assistance. Although each removes the individual from the segregated, self-contained class and places him or her in the regular classroom, as a group, hearing-impaired children continue to lag behind their hearing agemates in reading and academic achievement.

Mainstreaming suggests that individuals, particularly children, who meet certain academic standards be placed in general education settings. Social mainstreaming involves nonacademic activities such as art, gym, and music. Academic mainstreaming is reserved for those individuals whose achievement qualified them for placement in a mainstream setting such as the regular classroom. Inclusiveness attempts to combine aspects of both social and academic mainstreaming. No longer are particular achievement levels required in the practice of full inclusion.

Movement along the continuum of school placements, from those considered to be more restrictive to those considered least restrictive, is often an ideal for hearing-impaired individuals. Especially for hearing-impaired children, this ideal may not be met in real life educational situations, which may result in delayed or deferred development of the ability to function in a mainstream environment.

Although not without some controversy, there appears to be general consensus for the concept of mainstreaming the hearing-impaired individual and, to the extent possible, profoundly deaf students. Although placement of the young profoundly deaf individual in a mainstream classroom does not occur with great frequency, the availability of cochlear implants and similar technology does make it a more reachable social and academic goal. In either case, for purposes of this application, we expect that there are advantages ascribed to the mainstream setting which make it a viable placement choice for a substantial majority of hearing-impaired individuals.

A number of factors contribute to the feasibility of inclusive education for hearing-impaired individuals. With enhanced listening and speech skills made possible by cochlear implants and other technologies, hearing-impaired individuals may exhibit the numerous abilities needed for successful regular school placement. The success of hearing-impaired children in mainstream placements requires educational achievement, as well as social and emotional well-being. Educational progress includes, for example, reading and mathematics skills, in addition to the development of critical thinking skills. Social and emotional progress includes, for example, interactions with others in society. However, the social adjustment of hearing-impaired children in regular classrooms may be difficult. Whether regular education placement is labeled “inclusive” or “mainstream”, hearing-impaired children in these settings often need assistance to ensure success.

A goal of education for hearing-impaired persons is providing an environment that facilitates auditory learning, while simultaneously acknowledging the demands and the realities of a school day. This goal may be addressed by making it possible to become familiar with the classroom's routine, and role-playing real life examples to maximize habilitation.

Individual hearing-impaired subjects may be socially and academically successful in the classroom; academically successful, but having limited social interaction with other students; socially accepted but having some academic problems; having both social and academic challenges in the mainstream; and unsuccessful in the mainstream. The latter groups may be considered inappropriately placed, requiring habilitation in order to avoid insolation in a self-contained environment such as special schools. The inventive subject matter provides role-playing exercises to expand and reinforce the life-skills exercises provided in such special education environments, exercises to ease the transition to the mainstream, and support for the individual in remaining in the mainstream environment.

Factors beyond those of an individual's performance in the classroom are also expected to contribute to mainstream success. When an individual becomes an integral member of a school community, it is expected that social acceptance will follow. It is necessary to encourage the hearing-impaired individual to participate in classroom and after school activities, a task which is made easier by the use of the role-playing exercises of the inventive subject matter. There may be a need for repetitions to achieve communication and social proficiency, yet difficulty may arise if a teacher makes exaggerated exceptions to class routine which unnecessarily single out a hearing-impaired child. Although the hearing-impaired child is not like every other child in the class, the child will wish to be treated so. Role-playing in a protected environment, as provided in the inventive methods, will build confidence and achieve the repetitions needed to build competence.

Development of Skills Needed for Mainstreaming. A number of performance characteristics of hearing-impaired children in the mainstream suggest an advantage to mainstream placement, especially when considering academic achievement and speech production ability. Students placed in the mainstream attain higher levels on standardized tests of achievement than do their nonmainstreamed peers. For example, speech intelligibility of children in mainstream settings is often superior to those in special education classes. Some suggest that it is the lesser degree of hearing loss generally found in children in the mainstream which accounts for better speech intelligibility. It may also be that good speech intelligibility is part of the selection criteria for placement there. A third possibility is that students learn to articulate more clearly when they need to communicate with their hearing peers. Whatever the connection between mainstream placement and improved performance, developing sufficient competence for mainstream placement is an appropriate goal in the education of hearing-impaired persons.

The potential for success in the regular school setting is dependent upon competence in a number of skills required for general education placement. These skills include the subject's academic standing in his present classroom, the ability to articulate needs verbally, and appropriate social interaction with other children.

A candidate for mainstreaming should have good speech intelligibility, demonstrating simple conversational competence. This conversational competence should be demonstrated using acquired oral skills so that child-child and teacher-child communication can take place directly. Some children who lack sufficient overall communication competence are nevertheless placed in mainstream environments as a result of other academic needs and abilities. In such circumstances, they often rely upon an interpreter to facilitate conversation in the classroom. However, they may become socially isolated because of their inability to communicate directly with other students and teachers. The inventive subject matter provides exercises for developing and enhancing such communication skills. When a hearing-impaired individual has a positive self-image, mainstream success from a social perspective is a greater possibility.

A candidate for the mainstream will have been exposed to a curriculum commensurate with his age and grade level. This enables a relatively easy transition from the self-contained to the mainstream classroom with hearing agemates. It is expected that the methods for computer-assisted role-playing of the present invention will increase the skills levels of hearing-impaired individuals, making possible a successful transition to the mainstream for more hearing-impaired persons.

Regardless of experience, hearing-impaired individuals present with special needs, chief among them the understanding of idiomatic expressions, sophisticated vocabulary, and advanced grammatical structures of English. Although it is true that many hearing-impaired persons have enhanced auditory skills, it should be understood that they remain hearing-impaired and require instructional modifications to accommodate their language needs. Often, the only other alternative to mainstream placement is the self-contained classroom, in which the content and pace of the academic curriculum may not be sufficiently challenging.

Thus, the content of the exercises of the inventive subject matter are productively driven by the regular school curriculum and are utilized to provide the student with an opportunity to preview or review specific content of the lessons. The inventive subject matter also provides a bridge between the self-contained classroom and the mainstream classroom, allowing the hearing-impaired individual to build confidence and successfully make this transition.

Adolescent Individuals. Further complicating mainstream success, adolescence is probably one of the most difficult times for most individuals. It is a time for questioning all types of authority as well as oneself in order to determine one's position in life. For children with hearing impairment, these same problems exist, often in greater magnitude, because their ability to communicate with a majority of the population is compromised.

For an adolescent's successful interaction with the mainstream, identity, self-concept, and self-esteem are important attributes. Identity develops across a lifespan and is determined by intrapersonal, interpersonal, and environmental variables. Self-concept refers to how adolescents view and feel about themselves. Self-esteem involves the positive and negative evaluation that results when adolescents evaluate themselves. Often, adolescents with physical and other handicaps have negative body-image or other self-image, and have greater difficulty attaining positive self-concept and self-esteem.

To be successful in society as a whole, hearing-impaired adolescents must gain the ability to cope with their hearing loss on a day-to-day basis. Teenagers must be able to view their hearing loss as something which may be limiting but not devaluating. Training should include the acquisition of new social and coping skills which may help to restrict the effect of the hearing loss. For example, a profoundly deaf subject may believe that the best strategy to avoid errors in understanding is to monopolize conversation, an avoidance reaction to the communication exchange which eventually may defeat interaction altogether.

For example, training in interacting with others by listening may productively begin with a subject or aspect of sound that holds the most interest for the hearing-impaired individual. Sessions which deal with listening practice may address different levels of pattern perception, discrimination, and word recognition. The use of content material from classroom assignments may produce changes in the subject's understanding of the subject matter because the therapy will act as a review. Of course, improved performance is expected to give the subject more confidence, which will further reinforce the therapy overall.

As provided in the inventive subject matter, role-playing communication exchanges with other students may productively focus on listening and speaking activities to develop formal aspects such as conversation, information gathering, and discourse styles. Role-playing can also be employed to focus on informal and relaxed interactions such as those concerning the special interests, hobbies, or musical tastes of the individual. Above all, role-playing is used to develop the subject's trust and confidence.

Developing Communication Skills. Beyond simple audiologic criteria, a factor in the successful mainstream integration of a young person is the degree to which the child has begun to use a formalized system of language, and has an understanding that communication is functional. The individual must also demonstrate the use of abstract yet conventional symbols, either words or signs, to have needs and wants met, and to comment on his environment. The inventive subject matter targets early pragmatic skills and the development of communication skills in the hearing-impaired individual.

Examples of important basic communication skills include developing stimulus-response awareness; communicating that sound carries meaning; encouraging listening to voices, rather than relying on signing; encouraging natural and easy vocalizations; and improving overall intelligibility of speech.

Speech Production. Speech production is one of the more important skills which an individual, particularly an adolescent, may wish to improve, enhancing the ability to produce more intelligible speech. For example, ordering food in a restaurant may be a role-playing exercise which will help a subject to cope with these situations better. This type of activity incorporates both a listening behavior, when the waiter/waitress requests information from the customer, and a productive response. It provides the subject with a familiar experience which may be practiced at varying degrees of difficulty and requiring varying degrees of competency. To increase competence of this and other invaluable skills, the methods of the inventive subject matter provide role-playing exercises in a safe and secure environment which avoids awkwardness for the subject, and promotes better understanding by those role-playing a hearing-impaired individual.

Telephone Skills. Another exemplary speech and hearing skill is the use of the telephone. This skill requires a degree of intelligible speech and a threshold amount of auditory perception on the part of the subject. It requires that the person using the telephone be in control of the conversation and be able to convey meaning to the individual answering the telephone. Auditorally, use of the telephone requires that the user be able to discriminate between a dial tone, a telephone signal ring, a busy signal, and a person responding. In addition, the subject must be able to differentiate when the telephone is being answered in person, as distinguished from a recorded message.

After a connection has been made, the hearing-impaired subject making the call must explain the purpose of the call to the individual being called. In a basic telephone role-playing exercise, the call recipient responds to the caller's questions, answering yes or no, or asking for clarification. In this way, the hearing-impaired subject controls the conversation. Using the telephone also requires a high degree of speech intelligibility. As discussed in detail below, this can also be practiced in the inventive computer-assisted role-playing methods.

The Classroom Environment. There are certain ideal conditions of the school environment and characteristics of the teacher/student relationship which contribute to a successful educational experience. The environment in which education occurs should accommodate the individuality of the child, foster the development of a positive self-image, and provide the best academic curriculum. Teachers in ideal educational environments should appreciate the diversity of the children they teach, maintain a solid knowledge base regarding the numerous aspects of curriculum content, and reflect on their teaching practice in order to tailor it to the needs of the children in their classroom. In addition to providing exercise repetitions for the hearing-impaired individual, the inventive subject matter also provides a role-playing environment in which, for example, teachers can improve their skills in dealing with a hearing-impaired student.

Similarly, students should be enthusiastic learners who come to school to develop skills and social maturity commensurate with age and school placement. This goal applies whether the student is hearing or not. The inventive subject matter provides a role-playing environment in which subjects of any age are able to better develop skills and social maturity.

Habilitation to Hearing Devices. Implantation of a cochlear implant or use of a similar device to aid hearing is one method for providing hearing-impaired individuals with the tools to better integrate into society as a whole. And while adults require some degree of training for integration into mainstream society, there are differences between the adult population and the child population. One critical difference is in the area of postimplant habilitation.

In general, many adults who receive an implant respond well to postimplant training conducted in drill and practice type sessions in the hospital clinic after surgery. After a short period of listening practice, the adult often develops many of the auditory skills that are made possible by an implant. An adult is likely to be dismissed from therapy in a clinic after a fixed period of time, and seen subsequently only for the routine visits to set the device. In fact, many of the listening activities, once introduced by the therapist in the clinic, are relegated to home practice by the subject. The inventive subject matter provides an environment in which the subject can practice such auditory skills at home, without the need for the aid of a spouse or other companion.

Children, on the other hand, are found to be a more heterogeneous group with regard to their language abilities prior to implantation and needed more extensive training or rehabilitation. Potential candidates for implantation of the device range in age from two to seventeen years, have a continuum of language abilities from no formal system to complex language competence, have a number of communication systems including oral, cued speech, or signed communication, and have had vastly different educational placements ranging from residential school for the hearing-impaired to mainstream settings.

Because the insertion of the cochlear implant is a surgical procedure, a medical model of deafness is likely to drive the process of implantation. The medical model suggests that deafness is a condition to be diagnosed and treated, in this case with a cochlear implant. However, unlike other forms of medical intervention, implantation is a process and not simply a treatment. When a child receives a cochlear implant, the school has an important role in providing habilitation after surgery. Unlike adults who return to the implant center for drill and practice with the implant, a child generally returns to his local school for long-term education.

Issues of educational management of the individual with an implant do not end at any specified time after the individual receives the device. Rather, they grow and change as the individual moves through the educational system. The child's needs dictate the required aspects of development. At the time of implantation, issues of auditory learning may be of paramount importance. Subsequent success with the device may cause previously overshadowed problems to surface. For example, a profoundly deaf child achieving good auditory and speech skills may find his way into a mainstream classroom. There, general problems with learning may be detected as the pace of instruction is increased when compared to the careful and methodical teaching that generally occurs in the separate classroom for the hearing-impaired. Failure to address a learning problem that is observed later in the child's educational career may jeopardize past accomplishments made possible by the implant. Thus, the methods of the present inventive subject matter are expected to play an important role in the successful maturation of hearing-impaired children, especially those having cochlear implants.

The Deaf Community. Not all members of society accept the medical model of deafness described above, agree with the idea that deaf individuals should receive cochlear implants or similar technology, or accept the concept that deaf persons should attempt to fully integrate into mainstream society. The cultural model of deafness views deafness as a difference, not a deficit. In this model, those who are deaf form the Deaf Community, viewing themselves as a language and culture minority in which deafness is normal, not pathological. Although there are a number of quality of life issues that concern the Deaf Community, of significant importance to the Deaf Community is the education of deaf children. It is through the educational system that the language and culture of the Deaf are transmitted. However, even with the existence of the Deaf Community, hearing-impaired persons must interact with mainstream society as well. Thus, even individuals strongly committed to the principals of the Deaf Community may benefit from the inventive computer-assisted role-playing methods.

2. Auditory Processing Disorders. Auditory processing is the term used to describe what happens when the brain recognizes and interprets sounds. Humans hear when sound energy is transmitted through the ear and is changed into electrical information that can be interpreted by the brain. The disorder part of auditory processing disorder (“APD”) means that something is adversely affecting the processing or interpretation of information.

Individuals with APD often do not recognize subtle differences between sounds in words, even though the sounds themselves are loud and clear. Problems are more likely to occur when a person with APD is in a noisy environment or when he or she is listening to complex information. APD is alternately referred to as central auditory processing disorder, auditory perception problem, auditory comprehension deficit, central auditory dysfunction, central deafness, and so-called word deafness.

Auditory processing difficulty may be associated with conditions such as dyslexia, attention deficit disorder, autism, autism spectrum disorder, specific language impairment, pervasive development disorder, or developmental delay. Individuals with auditory processing difficulty, especially children, typically have normal hearing and intelligence. However, they have also been observed to have trouble paying attention to and remembering information presented orally; have problems carrying out multi step directions; have poor listening skills; heed more time to process information; have low academic performance; have behavior problems; have language difficulty such as confusing syllable sequences and have problems developing vocabulary and understanding language; and have difficulty with reading, comprehension, spelling, and vocabulary.

Several strategies are available to help individuals with auditory processing difficulty. Auditory trainers are electronic devices that allow a person to focus attention on a speaker and reduce the interference of background noise. For example, auditory trainers are used in school classrooms; the teacher wears a microphone to transmit sound and the subject wears a headset to receive the sound. Individuals who wear hearing aids can use them in addition to the auditory trainer.

Other, language-building exercises can increase the ability to learn new words and increase an individual's language base. Auditory memory enhancement, a procedure that reduces detailed information to a more basic representation, may improve vocabulary. Auditory integration training is sometimes promoted as a way to retrain the auditory system and decrease hearing distortion. The inventive subject matter provides a role-playing environment well suited to practicing the comprehension skills needed by individuals with APD.

3. Speech-Language Disorders. Speech is normally produced through a series of precisely coordinated muscle movements involving respiration, phonation, and articulation through the throat, palate, tongue, lips, and teeth. These muscle movements are initiated, coordinated, and controlled by the brain and monitored through the senses of hearing and touch. Speech-language impairment is a communication disorder such as stuttering, impaired articulation, a language impairment, or a voice impairment, which adversely affects educational and social success.

Speech-language disorders are disorders of speech production. They can be congenital or acquired. The act of producing understandable speech is very complex. The brain, having decided what message it wishes to send, must then send a series of signals to the speech muscles, telling them what to do. The muscles must then act in a coordinated fashion to produce the series of sounds intended.

Sounds can be classified in three ways: where in the mouth they are produced, how they are produced, and whether the voice box is on or off. A phonological process is an unusual rule that is being used and changes the place, manner, or voice of a group of sounds. Some phonological processes are: fronting, backing, gliding, cluster reduction, devoicing, stopping.

A child's communication is considered delayed when the individual is noticeably behind his or her peers in the acquisition of speech and/or language skills. Sometimes an individual has greater receptive than expressive language skills, but this is not always the case. Some causes of speech and language disorders include hearing loss, neurological disorders, brain injury, mental retardation, drug abuse, physical impairments such as cleft lip or palate, and vocal abuse or misuse.

A. Normal Speech and Language Development. Communication begins in infancy. Parents naturally interact with their infants in such a way as to promote communication. As children develop language, they typically go through essentially the same stages of development. The exact age at which a specific individual goes through a certain stage varies, but the order of the stages is generally the same from individual to individual.

### Birth to One Year

A baby's first attempts at communicating emotions and needs are through crying. Parents quickly learn how to differentiate hunger cries from those indicating tiredness or a wet diaper.

By three months, a baby turns his or her head towards voices and recognize parents' voices. Expressively, the baby indicates contentment and/or amusement by smiling. He or she repeats sounds.

At 4 to 6 months, the baby notices new sounds such as the vacuum and telephone. He or she responds to “no” and to changes in tone of voice. He or she pays attention to music. Early sound discrimination skills are beginning to emerge. Sounds have a more speech-like babble to them. When playing alone or with parents, the child makes gurgling sounds. He or she tells you by sound or gesture when he or she wants something.

At 7 months to one year, the infant begins to recognize his or her name. The child listens when spoken to. The baby begins to recognize common words, and to respond to requests like “Come here.” Vocabulary and concepts needed for reading begin here. Expressively, the infant imitates speech sounds, and he or she may have one or two words by one year. The baby more frequently uses speech or non-crying sounds to get and keep attention.

### One to Two Years

The child is able to participate more actively in listening to simple stories, songs, and rhymes. He or she can follow simple commands. The child can point to a few body parts. He or she can point to pictures of things in a book when you name them. The child's vocabulary is increasing, and he or she says more and more words every month. Some one or more word questions are used. The child begins to put a few words together. He or she uses many different consonant sounds at the beginning of words.

### Two to Three Years

The child begins to understand differences in meaning. The child notices noises, such as the doorbell ringing, the telephone, and sounds on the television. He or she follows requests or directions that have two parts to them. Expressively, the child has a word for almost everything, and he or she begins to use short phrases to talk about things and ask questions. He or she directs attention to or asks for objects by naming them. Familiar listeners understand the child's speech most of the time.

### Three to Four Years

The child now talks in sentences of four or more words. He or she talks about activities easily and fluently, without repeating syllables or words. People outside of the family are able to understand him or her. The child understands and answers simple who, what, and where questions. He or she hears when called from another room. He or she can hear the television or radio at the same loudness level as other family members. The child uses language for a number of purposes: to request, comment, question, answer, gain attention, protest, greet and perform social routines. At this age, children's understanding of language is usually greater than their language use.

### Four to Five Years

The child pays attention to short stories and answers simple questions about them. He or she understands most of what is said at home and at school. The child communicates easily with other children and adults. Sentences give details, and use adult-like grammar. When explaining something or telling a story, the child sticks to the topic and strings together ideas in an understandable sequence. The child may still have some errors in pronunciation, but is still easy to understand.

### Age 6 and older

As children enter school, their speech and language skills continue to develop. Their vocabulary grows, their sentences become longer and more complex. They are able to give definitions for words.

Their conversational skills improve and they can carry on conversations with adults. They can introduce a topic, continue it for several turns, and then close or switch topics. They can adjust their language to meet their partners' needs; they will repeat or rephrase when not understood. They know how and when to use polite language forms. Children improve their storytelling skills. Their stories have a definite beginning, middle, and end, and they tell the events in the proper order. They discover that sentences are made up of words, words are made up of syllables and sounds. They can break sentences and words up into their components. They learn to read.

By age 7, children understand and use the basic concepts of time, space and causality. They understand the meaning of many grammatical suffixes.

Between 7 and 11 years, children learn to use language for humor—many riddles and jokes are based on multiple word meanings. They understand idioms and figurative language. Perspective-taking skills improve and reading comprehension increases.

B. Articulation/Phonology Disorders. Both adults and children can have articulation problems. An individual with an articulation disorder can be hard to understand because they say sounds incorrectly. They might substitute one sound for another, distort the sound, or omit it entirely. An individual with a phonological disorder fails to use conventional rules about how sounds can be made or combined. Children who do not receive speech therapy and do not outgrow their speech difficulties continue to make speech errors as adults. Thus, there is a need for methods for improving the articulation skills of individuals with articulation/phonology disorders. The inventive subject matter provides a non-competitive, low pressure role-playing environment well suited to providing the repetitions and correction needed by individuals with articulation/phonology disorders.

C. Voice Disorders. As everyone's voice is unique, it is difficult to define a normal voice. A normal voice is pleasant sounding and has age and sex appropriate pitch and loudness. When a voice is not pleasant sounding, such as too loud or too soft, or too high or low for one's gender, a voice disorder may be present.

Voice is produced when the vocal folds come close together and air from the lungs sets them vibrating in a regular fashion. The vibration causes a series of pulses which in turn causes the air column in the vocal tract to resonate and produce voiced sound. Some sounds are produced without voice. When the vocal folds are brought together, the air pushes against the small opening and makes them vibrate, producing voicing. All vowels and some consonants are voiced.

Voice disorders are divided into two categories: organic voice disorders and functional voice disorders. Organic voice disorders stem from disease or pathology. Exemplary organic voice disorders include cancer, vocal fold paralysis, endocrine changes, granuloma, hemangioma, papilloma and laryngeal web. Functional voice disorders result from abuse or misuse of the voice, and can be managed by voice therapy. Misuse of the voice includes, talking too much or too loudly, yelling, or using an unnaturally deep or high pitch. Abuse occurs with nonverbal vocal behavior, for example excessive throat clearing, laughing, crying, coughing, and smoking. Misuse and abuse can cause physiological changes to the vocal folds, creating vocal nodules, polyps, contact ulcers, and edema.

Therapy for functional disorders involves identifying abuses and misuses, and reducing or eliminating them. Individuals sometimes need help finding their old voice if the disorder has been longstanding. The inventive subject matter provides a role-playing environment well suited to practicing the skills and exercises needed by individuals with voice disorders.

D. Dysfluencies. There are many different kinds of dysfluencies. Everyone has dysfluencies in their speech. Dysfluencies heard in the speech of normal speakers include fillers, hesitations, whole word and phrase repetitions, and revisions. Dysfluencies that are more characteristic of stuttering include sound or syllable repetition, prolongations or unnatural stretching out of sounds, and speech blocks. Stuttering can be differentiated from normal dysfluencies by the type, frequency, and duration of dysfluency. The average speaker has up to 7% dysfluencies of the types described above, which are usually rapid and don't slow speech down. Stuttering occurs at dysfluency frequencies of 10% or greater, can last up to 30 seconds, and is often accompanied by tension.

i. Stuttering. Speech disruptions in stuttering may be accompanied by rapid eye blinks, tremors of the lips and/or jaw or other struggle behaviors of the face or upper body that a person who stutters may use in an attempt to speak. Certain situations, such as speaking before a group of people or talking on the telephone, tend to make stuttering more severe, whereas other situations, such as singing or speaking alone, often improve fluency.

Many children go through a period of normal nonfluency between the ages of 2 and 5 years. The dysfluencies are usually whole word or phrase repetitions and interjections. The child does not demonstrate any tension in speech and is often unaware of any difficulty. It has been suggested that the cause of this nonfluency may be a combination of increases in language development, development of speech motor control, and environmental stresses that can occur in typical busy families. Some children outgrow these dysfluencies, while others do not.

It is believed that a number factors may play a role in the development and maintenance of stuttering. These factors can be grouped and classified as constitutional, environmental, and communication factors. There is evidence that stuttering is due to a disorder in the timing of movements of the speech muscles, a defect in auditory feedback, and a lack of cerebral dominance for language functions. The psychological side effects of stuttering include fear of speaking to strangers or in public.

There are a variety of treatments available for stuttering. Any of the methods may improve stuttering to some degree, but there is at present no cure for stuttering. Stuttering therapy, however, may help prevent developmental stuttering from becoming a life-long problem. Many of popular therapy programs for persistent stuttering focus on relearning how to speak or unlearning faulty ways of speaking. Therapy may be different depending on the age of the stutterer. Treatment approaches generally fall into two types: “speak more fluently” or “stutter more easily”. An integration of these two approaches is ideal for many individuals. The “speak more fluently” approach focuses on learning targets or fluency-enhancing skills such as easy onsets, light contacts, and blending. The “stutter more easily” approach helps the stutterer to reduce tension and modify his/her stuttering so that it doesn't interfere with his/her ability to communicate.

Especially in preschoolers and young borderline stutterers, environmental manipulation may be a successful approach. Environmental manipulation involves identifying variables in the child's environment that are increasing dysfluencies and then reducing or eliminating them. Some variables include: competition for talking time, listener loss, interruptions, pressure to speak or perform, too much or too little structure, sibling rivalry, fast-paced, busy environment, and high level of excitement. The methods of the inventive subject matter are well suited to practicing the skills needed to reduce dysfluencies in a non-competitive, low pressure, safe, and friendly environment.

Advanced stutterers must generally learn skills and strategies to manage their stuttering. Most fluency programs help a stutterer to feel more confident and to speak more fluently. Unfortunately, the gains made in therapy are not always maintained when therapy is finished. The stutterer must be motivated and dedicated to continue to practice their techniques as often as they need to in order to maintain their fluency. The methods of the inventive subject matter are well suited to practicing such techniques at home, without the need for a therapist or clinician.

ii. Cluttering. Cluttering involves excessive breaks in the normal flow of speech that seem to result from disorganized speech planning, talking too fast or in spurts, or simply being unsure of what one wants to say. In addition, there are a number of symptoms that may or may not be present, but add support to a diagnosis of cluttering: confusing, disorganized language or conversational skills, often with word-finding difficulties; limited awareness of his or her fluency and rate problems; temporary improvement when asked to slow down, pay attention to speech, or when being tape recorded; mispronunciations, slurring of speech sounds, or deleting non-stressed syllables in longer words; speech that is difficult to understand; several blood relatives who stutter or clutter; social or vocational problems resulting from cluttering symptoms; learning disabilities not related to reduced intelligence; sloppy handwriting; distractibility, hyperactivity, or a limited attention span; difficulty with organizational skills for daily activities; and/or auditory perceptual difficulties.

Therapy for clutterers generally addresses the contributing problems first before focusing directly on fluency. Ordinarily, one of the first goals of therapy is to reduce the speaking rate, starting with deliberate movements and maintaining deliberate, slow, and consistent marking of pauses. Pronunciation or articulation problems are often reduced if the clutterer can achieve a slower rate. The methods of the inventive subject matter are well suited to practicing rate-limiting and other skills.

Many clutterers also stutter, and often the cluttering is masked by the stuttering. In some of these individuals, the cluttering emerges as the individual gets control of the stuttering or begins to stutter less. Yet, whether or not the clutterer also stutters, or previously stuttered, any therapy techniques that focus attention on fluency targets such as easy onset of the voice, more prolonged syllables, or correct breathing, can also help the person to manage many of the cluttering symptoms. The important thing is that the clutterer learn to pay attention to—or monitor—his or her speech and do anything that makes it easier to remember to do so. The methods of the inventive subject matter are well suited to practicing the speech-monitoring skills needed by clutterers.

Many clutterers appear to be genuinely unaware of the extent of their cluttering behaviors. They must be taught to be astute observers of listener feedback. Clutterers who are not sure that they have a problem, or are relatively unconcerned about it, tend not to improve easily or improve much from therapy. These individuals may need continual affirmation and encouragement. The methods of the inventive subject matter are well suited for providing the repetitions, affirmation, and encouragement needed by clutterers.

E. Apraxia. Apraxia is a motor disorder in which volitional or voluntary movement is impaired without muscle weakness. Verbal apraxia, or apraxia of speech, is an impairment in the sequencing of speech sounds. Apraxic speakers grope for the correct word; they may make several attempts at a word before they get it right. The errors heard in apraxic speech are unpredictable.

Acquired apraxia can so severe that the individual is unable to initiate speech or so mild that an individual only has occasional difficulties in conversation pronouncing multi-syllabic words. Treatment approaches for apraxia of speech depend on the severity of the impairment. For people with moderate to severe apraxia, therapy may start by saying individual sounds and contrasting them, thinking about how the lips and tongue should be placed. Tapping or clapping out the rhythm of speech helps some speakers to speak more clearly. Contrastive stress drills use the natural rhythm of speech to increase intelligibility. Individuals with mild apraxia learn strategies to use to help them produce the longer words that give them trouble. For very severe apraxia, alternative and augmentative systems are often employed. The inventive subject matter provides a non-competitive, low pressure, safe, and friendly role-playing environment well suited to practicing the speech-production skills and other exercises needed by individuals with apraxia.

Developmental apraxia is generally present from birth and can so severe that the individual is unable to initiate speech or so mild that an individual only has occasional difficulties in conversation pronouncing multi-syllabic words. There are several treatment programs for developmental apraxia. Some approaches uses tactile cues. Traditional articulation therapies are modified, using phonetic placement and/or progressive approximation approaches. For children with limited expressive language, the development of a core vocabulary can simultaneously target improving speech. Therapy usually focuses on sound combinations and movement patterns rather than isolated sounds. Children also benefit from pairing speech with other rhythmic motor activities like clapping or marching. The methods of the inventive subject matter are well suited for providing the pattern repetitions and other exercises needed by individuals with apraxia.

F. Dysarthria. In order for speech to be clear, a number of subsystems must work together. The respiratory system supplies the air necessary to power the speech system. If the respiratory system is weak, then speech may be too quiet and produced one word at a time. The laryngeal system sets the air vibrating and creates voice. If the laryngeal system is weak, speech may be breathy, too quiet and slow. The velopharyngeal system acts a door between the oral and nasal cavities and channels air to one or both cavities resulting in different sound quality. If the velopharyngeal system is not working, speech may sound too nasal or nasal sounds may be missing. The articulatory system, consisting of the lips, tongue, teeth, and jaw, move to further channel and shape the sounds into the various vowels and consonants. If the articulatory subsystem is not working, speech may sound slurred, may have many errors, and may be slow and labored.

Dysarthria refers to speech disorders resulting from weakness or incoordination of the speech muscles. Speech is slow, weak, imprecise, or uncoordinated. It can affect both children and adults. “Childhood dysarthria” can be congenital or acquired. It is often a symptom of a disease, such as cerebral palsy, Duchenne muscular dystrophy, myotonic dystrophy, Bell's palsy, or the like. In both adults and children, dysarthria can result from head injury. In adults, dysarthria is can be caused by stroke; degenerative disease such as Parkinson's, Huntington's, amyotrophic lateral sclerosis, multiple sclerosis, or myasthenia gravis; infections such as meningitis; brain tumors; and toxins resulting from drug or alcohol abuse, lead poisoning, carbon monoxide, and the like.

Therapy for dysarthria focuses on maximizing the function of all speech-producing systems. Compensatory strategies are often used. Individuals with dysarthria may be advised to take frequent pauses for breath, to over-articulate, or to pause before important words to make them stand out. If there is muscle weakness, they may benefit from performing oro-facial exercises. This helps to strengthen the muscles of the face and mouth that are used for speech. The inventive subject matter is well suited to providing the exercises and skills needed by individuals with dysarthria.

G. Delayed Developmental Language Disorder. Children who do not develop language skills appropriately are language delayed or disordered. There are many potential causes for language delays/disorders in children, including hearing impairment, cognitive impairment, autism, physical handicap that prevents the child from interacting with their environment, and lack of stimulation.

Children can have receptive language impairments, expressive language impairments, or both. Some children do catch up to their peers, but many continue to have difficulty and the gap between their skill level and that of their peers may increase over time. Receptive language impairments mean that an individual has difficulty understanding language. They may have a limited vocabulary. They may not understand the meaning of word endings. They may have difficulty understanding nonverbal signals, like body language. They may not understand sarcasm, or indirect requests. Expressive language impairments show up in how an individual speaks. They may use only a few words in each sentence. They may omit word endings or little words. They may not always use language appropriately and appear to be rude by being too direct or blunt, or changing topics abruptly. The inventive subject matter provides a non-competitive, low pressure, safe, and friendly role-playing environment well suited to practicing the skills needed by individuals having such receptive and expressive language disorders.

H. Treatment of Speech-language Disorders. Communication has many components. All serve to increase the way people learn about the world around them, utilize knowledge and skills, and interact with colleagues, family, and friends. Because all communication disorders carry the potential to isolate individuals from their social and educational surroundings, it is essential to find appropriate, timely intervention.

While many speech and language patterns can be called “baby talk” and are part of a young child's normal development, they can become problems if they are not outgrown as expected. An initial delay in speech and language or an initial speech pattern can become a disorder which can cause difficulties in learning. Because of the way the brain develops, it is easier to learn language and communication skills before the age of five. When children have muscular disorders, hearing problems, or developmental delays, their acquisition of speech, language, and related skills is often affected.

Vocabulary and concept growth continues during the years children are in school. Reading and writing are taught and, as students get older, the understanding and use of language becomes more complex. Communication skills are at the heart of the education experience. Speech and/or language therapy may continue throughout a student's school year. The inventive subject matter provides a non-competitive, low pressure, safe, and friendly role-playing environment well suited to practicing the communication skills required for speech-language development and success in society.

4. Autism. Autism is a developmental disability significantly affecting verbal and non-verbal communication and social interaction, generally evident before age three, that adversely affects educational and social success. The inventive subject matter provides methods for the training and rehabilitation of autistic individuals having communication, educational, and/or social problems, in a safe, secure, and non-threatening role-playing environment.

5. Mental Retardation. Mental retardation is significantly subaverage general intellectual functioning existing concurrently with deficits in adaptive behavior and manifested during the developmental period, which adversely affects educational and social success. The inventive subject matter provides methods for the training and rehabilitation of mentally retarded individuals having communication, educational, and/or social problems, in a safe, secure, and non-threatening role-playing environment.

6. Multiple Disabilities. Multiple disabilities refers to simultaneous impairments, such as mental retardation/blindness, mental retardation/orthopedic impairment, etc., the combination of which causes such severe educational problems that the child cannot be accommodated in a special education program solely for one of the impairments. The inventive subject matter provides methods for the training and rehabilitation of individuals having communication, educational, and/or social problems resulting from multiple disabilities, in a safe, secure, and non-threatening role-playing environment.

7. Deaf-Blindness. Deaf-Blindness is simultaneous hearing and visual impairments, the combination of which causes such severe communication and other developmental and educational problems that an individual cannot be accommodated in special education programs solely for children with deafness or children with blindness. The inventive subject matter provides methods for the training and rehabilitation of deaf-blind individuals having communication, developmental, and/or social problems, in a safe, secure, and non-threatening role-playing environment.

8. Orthopedic Impairment. Orthopedic impairment is a severe orthopedic condition which adversely affects educational and social success. The term includes, for example, impairments caused by a congenital anomaly, such as clubfoot or absence of some member; impairments caused by disease, such as poliomyelitis, bone tuberculosis, or the like; and impairments from other causes, such as cerebral palsy, amputations, and fractures or burns which cause contractures. The inventive subject matter provides methods for the training and rehabilitation of orthopedically impaired individuals having educational and/or social problems, in a safe, secure, and non-threatening role-playing environment.

9. Serious Emotional Disturbance. Serious emotional disturbance is a condition exhibiting one or more of the following characteristics over a long period of time and to a marked degree, which adversely affects educational and social success: (A) an inability to learn which cannot be explained by intellectual, sensory, or health factors; (B) an inability to build or maintain satisfactory interpersonal relationships with peers and teachers; (C) inappropriate types of behavior or feelings under normal circumstances; (D) a general pervasive mood of unhappiness or depression; or (E) a tendency to develop physical symptoms or fears associated with personal or school problems. Serious emotional disturbance includes, for example, children who have schizophrenia. The inventive subject matter provides methods for the training and rehabilitation of individuals having communication, educational, and/or social problems resulting from serious emotional disturbance, in a safe, secure, and non-threatening role-playing environment.

10. Specific Learning Disability. Specific learning disability is a disorder in one or more of the basic psychological processes involved in understanding or in using language, spoken or written, which may manifest itself in an imperfect ability to listen, think, speak, read, write, spell, or to do mathematical calculations. The term includes, for example, such conditions as perceptual disabilities, brain injury, minimal brain dysfunction, dyslexia, and developmental aphasia. The inventive subject matter provides methods for the training and rehabilitation of individuals having problems in understanding and/or using language resulting from a specific learning disability, in a safe, secure, and non-threatening role-playing environment.

11. Traumatic brain injury. Traumatic brain injury is an injury to the brain caused by an external physical force, resulting in total or partial functional disability or psychosocial maladjustment, or both, which adversely affects educational and social success. The damage may be a closed head injury, such as that caused by a forceful collision between the head and an object, or a penetrating head injury, such as that caused by a something passing through the skull and piercing the brain. Some exemplary causes of head trauma are motor vehicle accidents, falls, sports injuries, violent crimes, and child abuse.

The physical, behavioral, or mental changes that may result from head trauma depend on the areas of the brain that are injured. Most injuries cause focal brain damage, damage confined to a small area of the brain. The focal damage is most often at the point where the head hits an object or where an object, such as a bullet, enters the brain.

In addition to focal damage, closed head injuries frequently cause diffuse brain injuries or damage to several other areas of the brain. The diffuse damage occurs when the impact of the injury causes the brain to move back and forth against the inside of the bony skull. The frontal and temporal lobes of the brain, the major speech and language areas, often receive the most damage in this way because they sit in pockets of the skull that allow more room for the brain to shift and sustain injury. Because these major speech and language areas often receive damage, communication difficulties frequently occur following closed head injuries.

Cognitive and communication problems that result from traumatic brain injury vary from person to person. These problems depend on many factors which include an individual's personality, pre-injury abilities, and the severity of the brain damage.

Language problems resulting from traumatic brain injury vary. Problems often include word-finding difficulty, poor sentence formation, and lengthy and often faulty descriptions or explanations. Individuals with traumatic brain injuries are often unaware of their errors and can become frustrated or angry and place the blame for communication difficulties on the person to whom they are speaking. Reading and writing abilities are often worse than those for speaking and understanding spoken words.

The speech produced by a person who has traumatic brain injury may be slow, slurred, and difficult or impossible to understand if the areas of the brain that control the muscles of the speech mechanism are damaged, producing dysarthria. Such individuals may also experience problems swallowing, or dysphagia. Others may have apraxia of speech, in which strength and coordination of the speech muscles are unimpaired but the individual experiences difficulty saying words correctly and consistently.

The cognitive and communication problems of traumatic brain injury are best treated early, often beginning while the individual is still hospitalized following the initial trauma. Early therapy frequently centers on increasing skills of alertness and attention; improving orientation to person, place, time, and situation; and stimulating speech understanding. Therapy may provide oral-motor exercises in cases where the individual has speech and swallowing problems.

Longer term rehabilitation often occurs in a rehabilitation facility designed specifically for the treatment of individuals with traumatic brain injury. The goal of rehabilitation is to help the individual progress to the most independent level of functioning possible. For some, ability to express needs verbally in simple terms may be a goal. For others, the goal of therapy may be to improve the ability to define words or describe consequences of actions or events.

Therapy focuses on regaining lost skills as well as learning ways to compensate for abilities that have been permanently changed because of the brain injury. Computer-assisted programs are expected to be successful with such individuals. The inventive subject matter provides methods for the training and rehabilitation of individuals having communication, educational, and/or social problems resulting from traumatic brain injury, and are particularly effective in addressing the need for increasing skills of alertness and attention; improving orientation to person, place, time, and situation; and stimulating speech understanding.

12. Visual Impairment. Visual impairment is a impairment to vision which, even with correction, adversely affects educational and social success. The term includes, for example, both individuals with partial sight and full blindness. The terms partially sighted, low vision, legally blind, and totally blind are used to describe individuals with visual impairments. Visual impairment is the consequence of a functional loss of vision, rather than the eye disorder itself. Exemplary eye disorders which can lead to visual impairments can include retinal degeneration, albinism, cataracts, glaucoma, muscular problems that result in visual disturbances, corneal disorders, diabetic retinopathy, congenital disorders, and infection.

Students with visual impairments often need additional help with special equipment and modifications in the regular educational curriculum to emphasize listening skills, communication, orientation and mobility, vocation/career options, and daily living skills. Students with low vision or those who are legally blind may need help in using their residual vision more efficiently and in working with special aids and materials. Students who have visual impairments combined with other types of disabilities have an even greater need for an interdisciplinary approach, and may require greater emphasis on self care and daily living skills. The inventive subject matter provides methods for the training and rehabilitation of visually impaired individuals having communication, educational, and/or social problems resulting from impaired listening skills, communication skills, orientation and mobility, vocation/career options, and daily living skills, in a safe, secure, and non-threatening environment.

13. Miscellaneous Disabilities. Miscellaneous health impairment refers to having limited strength, vitality, or alertness due to chronic or acute health problems such as attention deficit disorder, a heart condition, tuberculosis, rheumatic fever, nephritis, asthma, sickle cell anemia, hemophilia, epilepsy, lead poisoning, leukemia, or diabetes, which adversely affects educational and social success. The inventive subject matter provides methods for the training and rehabilitation of individuals having communication, educational, and/or social problems resulting from such health impairments, in a safe, secure, and non-threatening role-playing environment.

### Methods for Operating a Computer System to Simulate a Life Skill Environment

The inventive subject matter further relates to a method for operating a computer system to simulate a life skill environment, comprising the steps of:

A) storing a life skill simulation having a pre-determined goal on an information storage and retrieval device of a computer system;

B) utilizing an input device of said computer system, selecting a life skill simulation and a pre-determined goal for said life skill simulation;

C) utilizing an input device of said computer system, selecting at least two characters comprising:

(i) a first character in said simulation which is an active character played by a living subject,

(ii) a second character in said simulation which is either an active character played by an additional living subject or a simulated character generated by said computer system, and

(iii) additional optional character(s), each of which is either an active character played by an additional living subject or a simulated character generated by said computer system;

D) utilizing an input device of said computer system, selecting for each said character a disability mode for each of one or more selected disabilities,

wherein each said disability mode is selected from the group consisting of the presence of one or more symptoms of a selected disability and the absence of symptoms of the selected disability;

E) utilizing an output device of said computer system, presenting each subject with a visual stimulus and/or an aural stimulus permitting a response from said subject; and

F) monitoring a response, or lack thereof, by said subject for effectiveness of said response in achieving said goal.

It is expected that one of ordinary skill in the art will understand that a computer system refers generally to a device having at least an input device, a processor, a memory storage and retrieval device, and an output device. In this method for operating a computer system, the computer system receives input relating to said life skill simulation from a subject, processes said input according to a set of computer-readable instructions for processing input and generating output, and displays output relating to said life skill simulation to said subject. It is also expected that one of ordinary skill in the art will understand that a computer system refers any one of many devices—for example personal computers, network computers, mainframe computers, and the like—which have an input device, an output device, a processor, and a memory storage and retrieval device. Computer systems are commercially available and well known in the art.

Further, it is expected that one of ordinary skill in the art will understand that a set of computer-readable instructions for processing input and generating output need only follow the steps of the methods of the present invention to achieve the pre-determined goal(s) of a desired life skill simulation. By way of example and not limitation, the specific commands and programming language of a set of computer-readable instructions may be subject to many insubstantial variations and still be within the scope of the present inventive subject matter, so long as the steps of said computer-readable instructions for processing input and generating output, as provided in the inventive subject matter, are followed. Optionally, a clinician or the computer system may provide user feedback.

### EXAMPLES

The following examples are illustrative of the inventive subject matter and are not intended to be limitations thereon. Useful exercises which may be practiced in the inventive computer-assisted role-playing methods include, for example, responding to different styles of classroom presentation, responding to environmental sounds, responding to speech, responding to transitions in classroom routines, following directions, improving attention to classroom instruction, improving comprehension of classroom instruction, responding appropriately to content that is not understood, and interactions with peers. One of ordinary skill in the art will understand that the list of exercises is not exhaustive, but merely exemplary of the full range of the role-playing exercises contemplated by the present invention. It is to be understood that the response in each example described below is expected to progress from the least effective response for success, which is stated first, toward the most effective response for success, which is stated last.

### Example 1

The following example illustrates adaptation to different styles of classroom presentation. A disabled child exhibiting difficulty adapting to a mainstream classroom presents for habilitation. Using the computer-assisted role-playing methods according to the present invention, the child is trained in several styles of classroom presentation, including teacher directed, guest speaker, student speaker, group discussion, and co-operative learning situations. With repetition in a non-threatening environment, the child becomes more confident in different situations and is able to successfully make the transition to a mainstream classroom.

### Example 2

The following example illustrates training in the ability to differentiate environmental sounds. A hearing-impaired individual exhibiting difficulty differentiating environmental sounds presents for training. Using the computer-assisted role-playing methods according to the present invention, the person is trained to respond to sounds, if necessary beginning from a lack of awareness of environmental sounds and progressing to regular recognition of familiar sounds. With repetition in a non-threatening environment, the hearing-impaired individual becomes more confident in the ability to differentiate environmental sounds, and is able to successfully participate and gain acceptance in the mainstream.

### Example 3

The following example illustrates response to speech. A hearing-impaired individual exhibiting difficulty responding appropriately to speech presents for habilitation. Using the computer-assisted role-playing methods according to the present invention, the person is trained to respond to speech alone, if necessary beginning from a lack of apparent response to speech, progressing through understanding when able to look at the speaker, and ultimately understanding speech through hearing alone. With repetition in a non-threatening environment, the hearing-impaired individual becomes more confident in responding appropriately to speech, and is able to successfully participate and gain acceptance in the mainstream.

### Example 4

The following example illustrates adaptation to transitions in classroom routines. A disabled child exhibiting difficulty adapting to classroom transitions presents for habilitation. Using the computer-assisted role-playing methods according to the present invention, the child is trained to recognize and respond to several styles of classroom routines, if necessary beginning from a lack of awareness of routines or the inability to make transitions, progressing through making transitions with adult assistance or by observing others, and ultimately becoming fully aware of routines and making transitions independently. With repetition in a non-threatening environment, the child becomes more confident in different situations and is able to successfully adapt to changing routines in a mainstream classroom.

### Example 5

The following example illustrates attention to classroom directions and instruction. A disabled child exhibiting difficulty appropriately responding to classroom directions and instruction presents for habilitation. Using the computer-assisted role-playing methods according to the present invention, the child is trained in appropriate responses to classroom directions and instruction, if necessary beginning from disengagement and an inability to follow directions, progressing through following classroom directions and instruction with help and increasing attention to instruction, and ultimately becoming fully attentive and following directions and instruction independently. With repetition in a non-threatening environment, the child becomes more confident and attentive to classroom instruction, and is able to successfully participate and gain acceptance in a mainstream classroom.

### Example 6

The following example illustrates comprehension of classroom instruction. A disabled child exhibiting difficulty comprehending classroom instruction presents for habilitation and transition to a mainstream classroom. Using the computer-assisted role-playing methods according to the present invention, the child is exposed to increasingly less structured classroom instruction, if necessary beginning with information that is familiar and/or highly structured, progressing through an understanding of information that is new or less structured, and ultimately reaching full comprehension of all classroom instruction. With repetition in a non-threatening environment, the child becomes more confident and competent in understanding classroom instruction and is able to successfully participate and gain acceptance in a mainstream classroom.

### Example 7

The following example illustrates responding to content that is not understood. A disabled individual exhibiting difficulty responding appropriately to content that is not understood presents for habilitation. Using the computer-assisted role-playing methods according to the present invention, the person is trained to respond appropriately to content that is not understood, if necessary beginning with elimination of irrelevant response(s), progressing through acknowledgment of lack of understanding and looking to another for assistance, and ultimately specifically indicating content not understood. With repetition in a non-threatening environment, the individual becomes more confident his or her ability to identify content not understood and to gain understanding of such material through appropriate interaction with others.

### Example 8

The following example illustrates training in response to comments in lecture or teacher directed classroom recitation activities. A disabled child exhibiting difficulty responding appropriately to classroom recitation activities presents for habilitation. Using the computer-assisted role-playing methods according to the present invention, the child is trained respond appropriately to classroom recitation activities, if necessary beginning from disengagement or response inappropriate to the topic, progressing through eliciting an appropriate response from the subject, whether correct or incorrect, and ultimately reaching a situation in which the individual's volunteered responses are enriching to discussion of the recitation material. With repetition in a non-threatening environment, the child becomes more confident in his or her ability to respond and contribute to classroom activities, and is able to successfully participate and gain acceptance in a mainstream classroom.

### Example 9

The following example illustrates adaptation to a group discussion environment. A disabled individual exhibiting difficulty adapting to a group discussion environment presents for habilitation. Using the computer-assisted role-playing methods according to the present invention, the individual is trained to respond appropriately in a group discussion environment, if necessary beginning from disengagement from the group, progressing through increasing attentiveness to the group discussion and commenting, whether appropriately or inappropriately, and ultimately reaching full attentiveness to the group discussion and enriching the discussion with appropriate comments. With repetition in a non-threatening environment, the child becomes more confident in contributing to a group discussion, and is able to successfully participate and gain acceptance in a mainstream classroom.

### Example 10

The following example illustrates training in receptive and expressive interactions with peers. A disabled individual exhibiting difficulty interacting with peers presents for habilitation. Using the computer-assisted role-playing methods according to the present invention, the disabled individual is trained to respond appropriately when approached by another, and to appropriately initiate and respond interactions with peers, if necessary eliminating inappropriate interaction and developing the skill to respond appropriately to being approached, and to developing the skill to initiate interaction appropriately. With repetition in a non-threatening environment, the child becomes more confident in interacting with peers, and is able to successfully participate and gain acceptance in the mainstream.

The invention being thus described, it will be obvious that the same may be modified or varied in many ways. Such modifications and variations are not to be regarded as a departure from the spirit and scope of the invention and all such modifications and variations are intended to be included within the scope of the following claims.

We claim:

1. A method for computer-assisted role-playing of a life skill simulation by one or more living subject(s), comprising the steps of:
A) utilizing an input device of a computer system, selecting a life skill simulation available through said computer system;
B) utilizing an input device of said computer system, selecting at least two characters, comprising:
(i) a first character in said simulation which is an active character played by a living subject,
(ii) a second character in said simulation which is either an active character played by an additional living subject or a simulated character generated by said computer system, and
(iii) additional optional character(s), each of which is either an active character played by an additional living subject or a simulated character generated by said computer system;
C) utilizing an input device of said computer system, selecting for each said character a disability mode for each of one or more selected disabilities,
wherein each said disability mode is selected from the group consisting of the presence of one or more symptoms of a selected disability and the absence of symptoms of the selected disability;
D) utilizing an output device of said computer system, presenting each subject with a visual stimulus and/or an aural stimulus permitting a response from said subject;
E) monitoring a response, or lack thereof, for effectiveness of each subject in achieving a pre-determined goal of said life skill simulation;
F) assessing the effectiveness of each said response, or lack thereof, in achieving said pre-determined goal; and
G) providing feedback to a subject regarding the effectiveness of the subject's response in achieving said pre-determined goal.

2. The method of claim 1, wherein said computer system comprises a virtual reality input device, a virtual reality output device, a computer processor, an information storage and retrieval device, and a set of computer-readable instructions for processing input and generating output.

3. The method of claim 1, wherein said input is received from a subject through a device selected from the group consisting of a keyboard, a pointing device, a joystick device, a control button, a microphone, and combinations thereof.

4. The method of claim 1, wherein said output is displayed to a subject through a device selected from the group consisting of a display, a speaker, and combinations thereof.

5. The method of claim 4, wherein said output is displayed to a subject through a display and one or more speaker(s) incorporated into a virtual reality headset.

6. The method of claim 1, wherein said life skill simulation is selected from the group consisting of a school classroom simulation, a school recess simulation, a school library simulation, a school restroom simulation, a playtime simulation, a sports participation simulation, a locker room simulation, a social simulation, and a mealtime simulation.

7. The method of claim 6, wherein said life skill simulation is a classroom simulation.

8. The method of claim 1, wherein said at least two characters are selected from the group consisting of a disabled or impaired person, one or more teacher(s), one or more counselor(s), one or more physician(s), one or more peer(s) of said disabled or impaired person, one or more neutral observer(s), and one or more other person(s) appropriate to said life skill simulation.

9. The method of claim 1, wherein said at least two characters comprises one active character and one simulated character.

10. The method of claim 9, wherein said at least two characters consists of one active character and a plurality of simulated characters.

11. The method of claim 1, wherein said at least two characters comprises two active characters.

12. The method of claim 11, wherein said at least two characters consists of two active characters and at least one simulated character.

13. The method of claim 1, wherein each selected disability is selected from the group consisting of hearing impairment, deafness, speech or language impairment, communication disorders, visual impairment, neurological impairment, mental retardation, emotional disturbance, acquired brain injury, cerebral palsy, attention deficit hyperactivity disorder, mobility impairment, orthopedic impairment, other health impairment, autism, and combinations thereof.

14. The method of claim 13, wherein said hearing impairment is selected from the group consisting of minimal hearing loss, moderate hearing loss, severe hearing loss, unilateral hearing loss, total hearing loss, acclimation to hearing aid device(s), and acclimation to cochlear implant device(s).

15. The method of claim 1, wherein said speech disability is selected from the group consisting of stuttering, cluttering, impaired articulation, aphasia, dysarthria, apraxia, language impairment, and voice impairment.

16. The method of claim 1, wherein said step of assessing the effectiveness of said response includes the step of assessing the subject's ability to manage and successfully perform said life skill goal(s).

17. A method for operating a computer system to simulate a life skill environment, comprising the steps of:
A) storing a life skill simulation having a pre-determined goal on an information storage and retrieval device of a computer system;
B) utilizing an input device of said computer system, selecting a life skill simulation and a pre-determined goal for said life skill simulation;
C) utilizing an input device of said computer system, selecting at least two characters comprising:
(i) a first character in said simulation which is an active character played by a living subject,
(ii) a second character in said simulation which is either an active character played by an additional living subject or a simulated character generated by said computer system, and
(iii) additional optional character(s), each of which is either an active character played by an additional living subject or a simulated character generated by said computer system;
D) utilizing an input device of said computer system, selecting for each said character a disability mode for each of one or more selected disabilities,
wherein each said disability mode is selected from the group consisting of the presence of one or more symptoms of a selected disability and the absence of symptoms of the selected disability;
E) utilizing an output device of said computer system, presenting each subject with a visual stimulus and/or an aural stimulus permitting a response from said subject; and
F) monitoring a response, or lack thereof, by said subject for effectiveness of said response in achieving said goal.
